(19) United States
(12) Patent Application Publication
(10) Pub. No.: US 2025/0271818 A1
(43) Pub. Date: Aug. 28, 2025

(54) Manually Operated, Motor-Driven Working Device With Motor Control Circuit

(71) Applicant: Andreas Stihl AG & Co. KG, Waiblingen (DE)

(72) Inventors: Tobias ROTH, Ebersbach an der Fils (DE); Christoph WOHLFROM, Heubach (DE)

(21) Appl. No.: 18/675,269

(22) Filed: May 28, 2024

(30) Foreign Application Priority Data
Feb. 23, 2024 (DE) 10 2024 105 108.6

(51) Int. Cl. G05B 9/03; G05B 19/042

(52) U.S. Cl. CPC G05B 9/03; G05B 19/0428; G05B 2219/24182

(57) ABSTRACT

A manually operated motor-driven working device has a user-operated operating unit and a motor control circuit. The motor control circuit includes a control unit, configured to receive a motor operating signal from the operating unit and to generate a motor control signal on the basis thereof, a motor function enabling unit, configured to generate a motor function enable signal on the basis of a supplied enable control signal, and a redundancy control circuit, implemented as a discrete electrical circuit and configured to receive the motor operating signal and the motor control signal and to generate the enable control signal on the basis thereof.

### CROSS REFERENCE TO RELATED APPLICATION

This application claims priority under 35 U.S.C. § 119 from German Patent Application No. 10 2024 105 108.6, filed Feb. 23, 2024, the entire disclosure of which is herein expressly incorporated by reference.

### BACKGROUND AND SUMMARY

The invention relates to a manually operated motor-driven working device that has a user-operated operating unit and a motor control circuit. The device may be in particular a ground-based or handheld garden or forestry working device having a battery-powered electric motor or having an internal combustion engine, e.g. may be a chainsaw, an angle grinder, a strimmer or hedge clippers.

With working devices of this kind, as with many other devices, a redundant configuration for certain device components plays a major role, for example to increase functional or operating safety and/or as a protective measure against undesirable consequences of abnormal behavior from the device component in question. Often, the redundant configuration of a device component is also compulsory and thus a necessary measure for marketing or commissioning the device.

Examples that may be mentioned for such redundancy measures are the laid-open publication EP 2 292 383 A2, which discloses redundant overspeed protection for an electric tool, the laid-open publication DE 10 2015 212 934 A1, which discloses redundant sensor signal evaluation by means of appropriate comparator circuits, and the laid-open publication DE 10 2013 102 785 A1, which discloses a redundant implementation of a vehicle collision determination device.

It is an object of the invention to provide a manually operated motor-driven working device of the type cited at the outset that includes an implementation of the motor control circuit that is advantageous over the prior art, in particular in regard to realization complexity and/or functionality.

The invention achieves this and other objects by providing a manually operated motor-driven working device having a battery-powered electric motor or having an internal combustion engine, wherein the motor-driven working device has a user-operated operating unit and a motor control circuit, the motor control circuit comprising a specific configuration.

Advantageous developments of the invention are specified in the dependent claims, the wording of which is hereby rendered part of the description by way of reference. This also includes, in particular, all embodiments of the invention that result from the combinations of features defined by the dependency references in the dependent claims.

In the working device according to the invention, the motor control circuit comprises a control unit, a motor function enabling unit and a redundancy control circuit. The control unit is configured to receive a motor operating signal from the operating unit and to generate a motor control signal on the basis thereof. Normally, the control unit is implemented using integrated circuitry or as a microchip or microcontroller module and acts as a central motor control unit of the device, for example. The motor function enabling unit is configured to generate a motor function enable signal on the basis of a supplied enable control signal. The redundancy control circuit is implemented as a discrete electrical circuit and configured to receive the motor operating signal and the motor control signal and also to generate the enable control signal on the basis thereof.

It is found that in particular the discrete implementation of the redundancy control circuit can achieve advantages in regard to realization complexity and functionality of the motor control circuit having the redundancy control circuit, specifically also compared with an alternative implementation of a functionally similar redundancy control circuit as an integrated circuit or as a chip-integrated control circuit and/or in part or completely in software. This comparatively simple and inexpensive configuration of the redundancy control circuit as a discrete electrical circuit can advantageously be used for example in ground-based or handheld garden or forestry working devices having a battery-powered electric motor, such as for battery-powered chainsaws, hedge clippers and strimmers, but also for other manually operated motor-driven working devices, such as angle grinders, etc.

Specifically, the redundancy control circuit is used in the present invention to provide a redundant and therefore safety-increasing assessment of the motor control signal generated by the control unit on the basis of the received motor operating signal. In other words, the redundancy control circuit provides redundancy for the control unit specifically with reference to the assessment of the motor operating signal. The redundancy control circuit accordingly provides the motor function enabling unit with the enable control signal subject to this redundant and therefore safety-increasing assessment of the motor control signal on the basis of the motor operating signal supplied to it in parallel with the control unit of the motor control circuit. The motor function enabling unit takes the enable control signal generated in such a redundantly safety-increasing manner as a basis for generating the motor function enable signal, which triggers the enabling of a predefined motor function. This motor function may be e.g. starting or may be adjusting the performance of the battery-powered electric motor or internal combustion engine of the device, or may alternatively be another function for this motor.

In a development of the invention, the redundancy control circuit comprises a comparator circuit section, the input side of which receives the motor operating signal, a threshold value circuit section, which is connected downstream of the comparator circuit section and receives an output signal of the comparator circuit section, and a logic circuit section, which receives the motor control signal and an output signal of the threshold value circuit section and delivers the enable control signal. This is an implementation of the redundancy control circuit that is beneficial in terms of minimizing the circuit realization complexity. The comparator circuit section can be used by the input side of the redundancy control circuit to assess the supplied motor operating signal, the downstream threshold value circuit section facilitates advantageous further processing of the output signal delivered by the comparator circuit section, for example including for the purpose of implementing suitable hysteresis characteristics, and the output-side logic circuit section facilitates generation of the enable control signal with simple circuitry by assessing the motor control signal on the basis of the output signal delivered by the threshold value circuit section.

In a refinement of the invention, the comparator circuit section has an operational amplifier. Such use of an operational amplifier for a comparator circuit is a measure that is typically beneficial for many applications.

In another refinement of the invention, the motor operating signal is an Active-high signal applied to an inverting input of the operational amplifier or an Active-low signal applied to a noninverting input of the operational amplifier. This allows the motor operating signal, e.g. implemented as a binary digital signal, to be supplied to the input side of the operational amplifier as appropriate in each case.

In another refinement of the invention, the redundancy control circuit has a level hysteresis circuit path between an input side of the operational amplifier and an output side of the threshold value circuit section. This is an embodiment of the redundancy control circuit that is advantageous for desired hysteresis characteristics in terms of the signal levels involved.

In another refinement of the invention, the comparator circuit section comprises a prefilter circuit connected upstream of the operational amplifier. The prefilter circuit can perform a debounce function for the motor operating signal supplied to the operational amplifier, in a manner known per se.

In another refinement of the invention, the comparator circuit section comprises a time delay circuit connected downstream of the operational amplifier. The time delay circuit allows a desired time delay to be provided for the processed motor operating signal according to need.

In a more extensive refinement of the invention, the time delay circuit has a switch-on delay section having a predefinable switch-on time constant and/or a switch-off delay section having a predefinable switch-off time constant. Depending on need and the application, the corresponding implementation of the time delay circuit facilitates a desired time delay for the processed motor operating signal when this signal is switched on or switched off using the switch-on delay section or switch-off delay section in question. Switch-on is intended to be understood here in the present case to mean a signal state of the motor operating signal that requests the activation of the motor function in question, switch-off being intended to be understood to mean the signal state of the motor operating signal that requests the deactivation of this motor function.

In an even more extensive refinement of the invention, the switch-on time constant is less than 100 ms, in particular less than 6 ms. It is found that this choice of switch-on time constant leads to an optimum switch-on delay time for the motor operating signal for many applications.

In an even more extensive refinement of the invention, the switch-off time constant is greater than 100 ms, in particular greater than 180 ms, and less than 220 ms. It is found that this choice of switch-off time constant leads to an optimum delay for the motor operating signal in its switch-off signal state for many applications.

In an even more extensive refinement of the invention, the switch-on time constant is smaller than the switch-off time constant. This choice of shorter time delay for switching on compared with switching off proves beneficial for many applications.

In a development of the invention, the motor control circuit comprises a status information circuit path that is routed from an output side of the redundancy control circuit to an input side of the control unit. This measure facilitates the provision of status feedback from the redundancy control circuit to the control unit, with the result that the control unit can use this status feedback according to need.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a side view of a chainsaw as an example of a manually operated motor-driven working device according to the invention, which has a user-operated operating unit and a motor control circuit having a discrete redundancy control circuit;

FIG. 2 is a block diagram of the operating unit and the motor control circuit;

FIG. 3 is a circuit diagram of a first implementation of the discrete redundancy control circuit;

FIG. 4 is a circuit diagram of a second implementation of the discrete redundancy control circuit;

FIG. 5 is a circuit diagram of a third implementation of the discrete redundancy control circuit;

FIG. 6 is a circuit diagram of a fourth implementation of the discrete redundancy control circuit; and

FIG. 7 is a circuit diagram of a fifth implementation of the discrete redundancy control circuit.

### DETAILED DESCRIPTION OF THE DRAWINGS

As illustrated in the figures on the basis of the implementations shown therein, the manually operated motor-driven working device according to the invention includes a user-operated operating unit 1 and a motor control circuit. The motor control circuit comprises, as illustrated in the block diagram of FIG. 2, a control unit 2, a motor function enabling unit 3 and a redundancy control circuit 4. The control unit 2 is configured to receive a motor operating signal BS from the operating unit 1 and to generate a motor control signal SS on the basis thereof. The motor function enabling unit 3 is configured to generate a motor function enable signal MS on the basis of a supplied enable control signal FS. The redundancy control circuit 4 is implemented as a discrete electrical circuit and configured to receive the motor operating signal BS and the motor control signal SS and to generate the enable control signal FS on the basis of the received motor operating signal BS and of the received motor control signal SS.

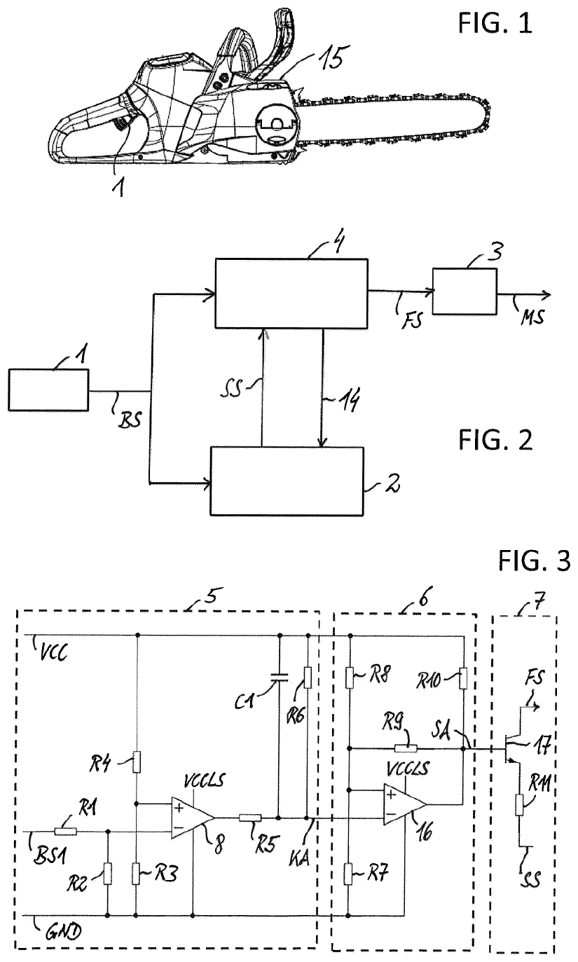

In a manner representative of many other working devices according to the invention, FIG. 1 shows as a working device a chainsaw 15 having a battery-powered electric motor. In this case, in a manner known per se, the operating unit 1 may comprise for example a throttle, or motor performance, switch and optionally additionally an on/off switch, or motor start switch, and/or an unlock switch that can be operated in order to release a lock for the motor performance switch. The motor operating signal BS in this case may accordingly be e.g. a motor start signal from the motor start switch or a performance adjustment signal from the throttle, or motor performance, switch.

FIGS. 3 to 7 provide an exemplary illustration of various circuit realizations for the discrete redundancy control circuit 4, these realizations being chosen differently according to the type of the supplied motor operating signal BS and according to specifically desired optional functions.

In corresponding embodiments, the redundancy control circuit 4, as in the implementations shown, comprises an input-side comparator circuit section 5, a threshold value circuit section 6, connected downstream thereof, and an output-side logic circuit section 7. The input side of the comparator circuit section 5 receives the motor operating signal BS. The threshold value circuit section 6 receives an output signal KA of the comparator circuit section 5. The logic circuit section 7 receives the motor control signal SS and an output signal SA of the threshold value circuit section 6 and delivers the enable control signal FS.

In advantageous implementations, the comparator circuit section 5, as in the implementations shown, has an operational amplifier 8.

In corresponding realizations, the motor operating signal BS is an Active-high signal applied to an inverting input of the operational amplifier 8, i.e. a preferably binary signal that requests motor function activation when it is at a high level. FIGS. 3, 4 and 7 show a motor operating signal BS1, which is an Active-high signal such as this, that has been applied to the inverting input of the operational amplifier 8.

In alternative implementations, the motor operating signal BS is a preferably binary Active-low signal that is applied to a noninverting input of the operational amplifier 8. FIGS. 5 to 7 show a motor operating signal BS2, which is an Active-low signal such as this, that is applied to the noninverting input of the operational amplifier 8.

As FIGS. 3 to 7 illustrate, the configuration of the discrete redundancy control circuit 4 is in each case suitably adjusted for whether the supplied motor operating signal BS is an Active-high signal, here the signal BS1, or an Active-low signal, here the signal BS2, FIG. 7 showing a circuit realization in which both motor operating signals, the Active-high signal BS1 and the Active-low signal BS2, are supplied to the redundancy control circuit 4.

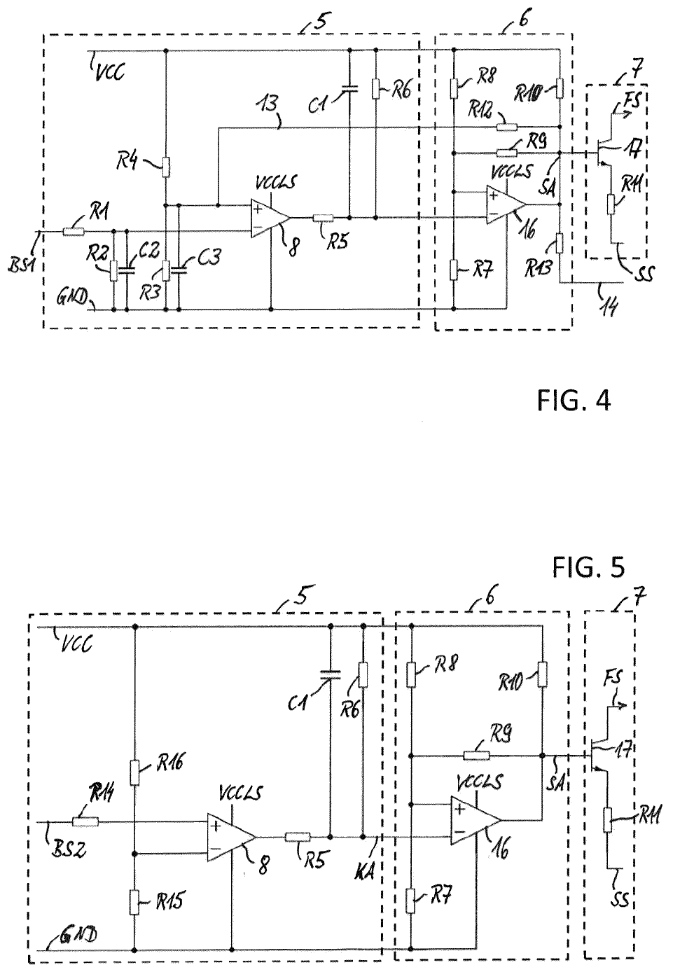

In advantageous implementations, the redundancy control circuit 4 has a level hysteresis circuit path 13 between an input side of the operational amplifier 8 and an output side of the threshold value circuit section 6. There is provision for such a level hysteresis circuit path 13 in the circuit realizations according to FIGS. 4, 6 and 7.

In corresponding realizations, the comparator circuit section 5, as in the implementations shown, comprises a prefilter circuit 9 connected upstream of the operational amplifier 8. The prefilter circuit 9 is explicitly marked using dashed lines in FIG. 7, and is likewise present in different circuit realizations in FIGS. 3 to 6.

In advantageous realizations, the comparator circuit section 5 comprises a time delay circuit 10 connected downstream of the operational amplifier 8. This too is present in each of the implementations of the redundancy control circuit 4 according to FIGS. 3 to 7 and, for the sake of simplicity, is explicitly marked using a dashed frame only in FIG. 7.

In corresponding realizations, the time delay circuit 10, as in the examples shown, has a switch-on delay section 11 having a predefinable switch-on time constant. The switch-on delay section 11 is again marked using a dashed frame in FIG. 7.

In corresponding realizations, the time delay circuit 10, as in the examples shown, has a switch-off delay section 12 having a predefinable switch-off time constant. The switch-off delay section 12 is again marked using a dashed frame in FIG. 7.

In corresponding circuit configurations, the switch-on time constant provided by the switch-on delay section 11 is smaller than the switch-off time constant provided by the switch-off delay section 12. Specifically, the switch-on time constant in corresponding realizations is less than 100 ms, preferably less than 6 ms. The switch-off time constant is greater than 100 ms in preferred realizations, and may be in particular between 180 ms and 220 ms.

In advantageous embodiments, the motor control circuit has a status information circuit path 14 that is routed from an output side of the redundancy control circuit 4 to an input side of the control unit 2. This status information circuit path 14 is present for example in the circuit implementations of the redundancy control circuit 4 according to FIGS. 4, 6 and 7.

FIGS. 3 to 7 show the circuit design of the redundancy control circuit 4 in various exemplary implementations, which are discussed in more detail below.

FIG. 3 shows the redundancy control circuit 4 in a basic version, as suitable for the Active-high motor operating signal BS1. The motor operating signal BS1 is applied via an input resistor R1 to the inverting input of the operational amplifier 8, which is connected to an earth potential GND via a resistor R2. The noninverting input of the operational amplifier 8 is connected to the centre tap of a voltage divider containing two resistors R3 and R4 that is looped in between the earth potential GND and a supply voltage VCC. The three resistors R1, R2, R3 are parts of the prefilter circuit 9 in this case.

For power supply, the operational amplifier 8 is connected to the earth potential GND and a voltage connection VCCLS, as customary. An output signal of the operational amplifier 8, routed via a resistor R5, forms the output signal KA of the comparator circuit section 5. A capacitor C1 looped in between the output of the comparator circuit section 5 and the supply voltage VCC, together with the resistor R5, forms the switch-on delay section 11 of the time delay circuit 10. In parallel with the capacitor C1, a resistor R6 is looped in between the output of the comparator circuit section 5 and the supply voltage VCC. Said resistor, together with the capacitor C1, forms the switch-off delay section 12 of the time delay circuit 10 of the comparator circuit section 5.

In all of the implementations shown, the threshold value circuit section 6 includes an operational amplifier 16 effectively arranged in cascaded fashion in relation to the operational amplifier 8, the output signal KA of the comparator circuit section 5 being applied to the inverting input of the operational amplifier 16. The noninverting input of the operational amplifier 16 is connected to a centre tap of a voltage divider comprising two resistors R7 and R8 between the earth potential GND and the supply voltage VCC.

An output signal of the operational amplifier 16 forms the output signal SA of the threshold value circuit section 6. The output of the operational amplifier 16 is fed back to the noninverting input of the operational amplifier 16 via a resistor R9. In addition, the output of the operational amplifier 16 and thus of the threshold value circuit section 6 is connected to the supply voltage VCC via a resistor R10.

In all of the implementations shown, the logic circuit section 7 comprises a transistor 17, which may be e.g. a bipolar transistor, such as one of IGBT type. The output signal SA of the threshold value circuit section 6 is applied to a base connection of the transistor 17. An emitter connection of the transistor 17 has the motor control signal SS generated by the control unit 2 applied to it via a resistor R11. A collector connection of the transistor 17 delivers the enable control signal FS as the output signal of the logic circuit section 7 and thus of the redundancy control circuit 4. The transistor switch 17 effectively forms AND logic that ensures that the enable control signal FS is provided only if indicated both by the supplied motor control signal SS of the control unit 2 and by the output signal SA delivered by the redundancy control circuit 4.

FIG. 4 shows the redundancy control circuit 4 in an implementation that is based on that of FIG. 3 and contains some additional, optional components. With the exception of the supplementary components explained below, reference may therefore be made to the above explanations relating to FIG. 3 for the circuit implementation of FIG. 4.

In the input-side section of the redundancy control circuit 4, the circuit implementation of FIG. 4 includes, in addition to that of FIG. 3, a capacitor C2 connected in parallel with the resistor R2 and a capacitor C3 connected in parallel with the voltage divider resistor R3. The capacitors C2 and C3 form optional parts for the prefilter circuit 9.

In addition, the circuit implementation of FIG. 4 includes a resistor R12 that connects the noninverting input of the operational amplifier 8 to the output of the threshold value circuit section 6 and thereby forms the level hysteresis circuit path 13.

Additionally, the threshold value circuit section 6 in the circuit implementation of FIG. 4 has an outgoing circuit from the output of the operational amplifier 16 via a resistor R13. This outgoing circuit acts as the status information circuit path 14, via which the control unit 2 can be supplied with applicable status information by the redundancy control circuit 4.

FIG. 5 shows the redundancy control circuit in a basic implementation, as is suitable for processing the Active-low motor operating signal BS2. Where identical or functionally equivalent circuit components to those in FIGS. 3 and 4 are used here, reference is made to the above explanations pertaining to FIGS. 3 and 4 in this regard to avoid repetitions.

In the circuit implementation of FIG. 5, the motor operating signal BS2 is applied to the noninverting input of the operational amplifier 8 via a resistor R14. In this case, the inverting input of the operational amplifier 8 is connected to the centre tap of a voltage divider containing two resistors R15 and R16 between the earth potential GND and the supply voltage VCC. In this respect, the prefilter circuit 9 is therefore also modified compared with the implementations of FIGS. 3 and 4.

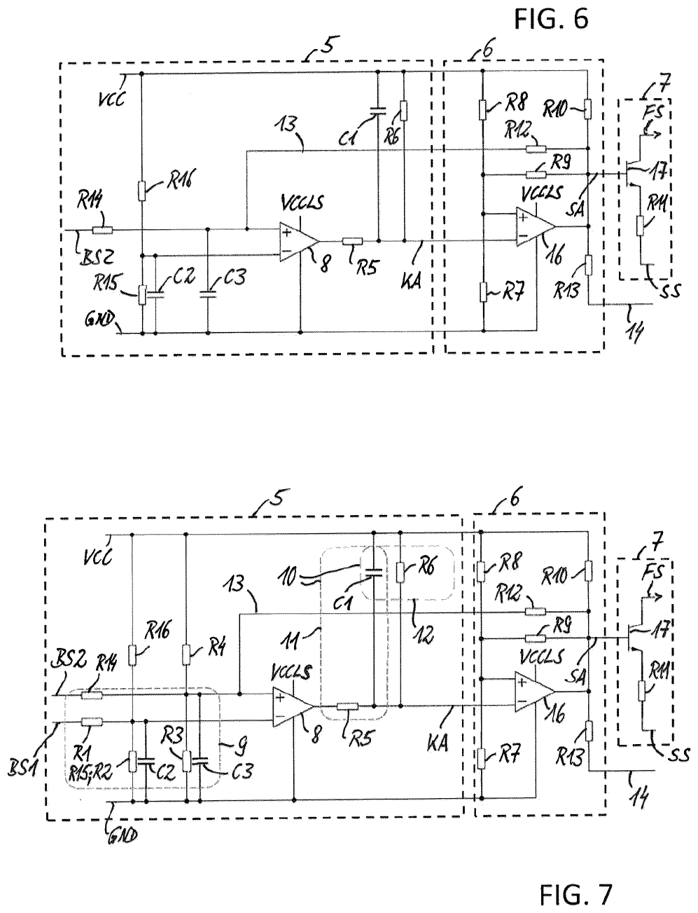

FIG. 6 shows a circuit implementation that is based on that of FIG. 5 and has additional components analogous to those in the circuit of FIG. 4. Specifically, the circuit of FIG. 6 includes the capacitor C2 between the inverting input of the operational amplifier 8 and the earth potential GND and the capacitor C3 between the noninverting input of the operational amplifier 8 and the earth potential GND as applicable parts of the prefilter circuit 9. Similarly, the circuit of FIG. 6 comprises the resistor R12 and the level hysteresis circuit path 13 formed thereby and also the resistor R13 and the status information circuit path 14 formed thereby.

FIG. 7 shows the redundancy control circuit 4 in a circuit realization that is suitable for processing or assessing both the Active-high motor operating signal BS1 and the Active-low motor operating signal BS2 and, to this end, suitably combines the applicable circuit components of the implementations according to FIGS. 4 to 6. Based on the circuit realization according to FIG. 6, for example, the circuit implementation according to FIG. 7 additionally includes the voltage divider containing the resistors R3 and R4, the centre tap of which has the noninverting input of the operational amplifier 8 connected to it, with the voltage divider resistor of the other voltage divider, the centre tap of which has the inverting input of the operational amplifier 8 connected to it, corresponding to the resistor R15 of the circuits according to FIGS. 5 and 6 and to the resistor R2 of the circuits according to FIGS. 3 and 4.

As is made clear by the exemplary embodiments shown and the other exemplary embodiments explained above, the invention advantageously provides a manually operated motor-driven working device in which the motor control circuit, redundantly with respect to the normally more complex control unit implemented with a greater scope of functions, has the redundancy control circuit as an electrical circuit that is advantageously implemented in a simple manner using discrete circuitry. This can save significant production complexity compared with duplicated provision of two control units, normally realized using integrated architecture or as a microchip or microcontroller, in the style of the single control unit in the present case. The redundancy control circuit can be designed specifically for, and restricted to, performing the functions required for the redundant assessment of the motor operating signal delivered by the operating unit, without needing to perform the additional functions typically required for the control unit, which in such working devices is usually used as a central device control unit, or a controller unit manufactured using integrated circuitry.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A manually operated motor-driven working device having a battery-powered electric motor or having an internal combustion engine, the motor-driven working device comprising:
a user-operated operating unit; and
a motor control circuit, the motor control circuit comprising:
a control unit, configured to receive a motor operating signal from the operating unit and to generate a motor control signal on the basis thereof,
a motor function enabling unit, configured to generate a motor function enable signal on the basis of a supplied enable control signal, and
a redundancy control circuit, implemented as a discrete electrical circuit and configured to receive the motor operating signal and the motor control signal and to generate the enable control signal on the basis thereof.

2. The working device according to claim 1, wherein the redundancy control circuit comprises:
a comparator circuit section, the input side of which receives the motor operating signal;
a threshold value circuit section, which is connected downstream of the comparator circuit section and receives an output signal of the comparator circuit section; and
a logic circuit section, which receives the motor control signal and an output signal of the threshold value circuit section and delivers the enable control signal.

3. The working device according to claim 2, wherein the comparator circuit section has an operational amplifier.

4. The working device according to claim 3, wherein
the motor operating signal is an Active-high signal applied to an inverting input of the operational amplifier or an Active-low signal applied to a noninverting input of the operational amplifier.

5. The working device according to claim 3, wherein
the redundancy control circuit comprises a level hysteresis circuit path between an input side of the operational amplifier and an output side of the threshold value circuit section.

6. The working device according to claim 3, wherein
the comparator circuit section comprises a prefilter circuit connected upstream of the operational amplifier.

7. The working device according to claim 3, wherein
the comparator circuit section comprises a time delay circuit connected downstream of the operational amplifier.

8. The working device according to claim 7, wherein
the time delay circuit has at least one of a switch-on delay section having a predefinable switch-on time constant and a switch-off delay section having a predefinable switch-off time constant.

9. The working device according to claim 8, wherein the switch-on time constant is smaller than the switch-off time constant.

10. The working device according to claim 8, wherein the switch-on time constant is less than 100 ms.

11. The working device according to claim 10, wherein the switch-on time constant is less than 6 ms.

12. The working device according to claim 8, wherein the switch-off time constant is greater than 100 ms and less than 220 ms.

13. The working device according to claim 12, wherein the switch-off time constant is greater than 180 ms and less than 220 ms.

14. The working device according to claim 1, wherein
the motor control circuit comprises a status information circuit path that is routed from an output side of the redundancy control circuit to an input side of the control unit.

15. The working device according to claim 1, wherein the working device is a ground-based or handheld garden or forestry working device.
